(19) United States
(12) Patent Application Publication
(10) Pub. No.: US 2009/0019318 A1
(43) Pub. Date: Jan. 15, 2009

(54) Approach for monitoring activity in production systems

(76) Inventors: Peter Cochrane, Saratoga, CA (US); Mary Ann Cochrane, Saratoga, CA (US)

Correspondence Address: HICKMAN PALERMO TRUONG & BECKER, LLP, 2055 GATEWAY PLACE, SUITE 550, SAN JOSE, CA, 95110, US

(21) Appl. No.: 11/827,156

(22) Filed: Jul. 10, 2007

(51) Int. Cl. G06F 11/34

(52) U.S. Cl. 714/47; 714/E11.192

(57) ABSTRACT

An approach is provided for monitoring of the activity in production computer systems. During a first period of time, substantially all of a first plurality of dispatches sent to a CPU are recorded. Each dispatch of the first plurality of dispatches indicates an initial instruction of a stream of instructions that is executed without interruption by the CPU. Based on the first plurality of dispatches, a baseline profile that indicates a normal execution flow in the system is generated. During a second period of time, substantially all of a second plurality of dispatches sent to the CPU are monitored. Based on the baseline profile and on at least one of the second plurality of dispatches, a determination is made whether an abnormal execution flow exists in the system during the second period of time. One or more actions are performed in response to determining that the abnormal execution flow exists in the system during the second period of time.

### FIELD OF THE INVENTION

This invention relates generally to computer system monitoring and more specifically, to an approach for real-time, activity-based monitoring of production computer systems.

### BACKGROUND

The approaches described in this section are approaches that could be pursued, but not necessarily approaches that have been previously conceived or pursued. Therefore, unless otherwise indicated, the approaches described in this section may not be prior art to the claims in this application and are not admitted to be prior art by inclusion in this section.

Unexpected work and missing work performed in a production system with repetitive workloads may disrupt planned work and may result in budgets being exceeded. This problem is difficult to control in production systems in which users would like to have a tight control on what is executing in the systems. In addition, it is difficult to monitor in real-time what is executing in production systems and to detect unplanned work or activity. Examples of unplanned work or activity include, but are not limited to, a program submitted by a user that is not supposed to run, a program that is supposed to run but ends unexpectedly, a new version of a program, or unexpected data being processed by a program.

For example, consider a mainframe computer system that is dedicated to performing accounting tasks. Unplanned work or activity in the system may include the execution of an application that is not an accounting application or an accounting application that ends unexpectedly. In another example, a program that normally executes in a production system may be upgraded. In this example, unplanned activity may occur if after the upgrade the execution of the program becomes inefficient and adversely affects the execution of other programs.

In general, abnormal behavior in a production system caused by unplanned activity may be malicious or benign; thus, in production systems it is desirable to detect such abnormal behavior in real or near real-time so that actions may be quickly taken to control and/or correct the unplanned activity that caused the abnormal behavior. However, in most production systems it is difficult and computationally expensive to monitor processes as they execute in real-time because the monitoring itself is very expensive.

One approach for monitoring a production system involves performing an analysis of whether the system is exhibiting abnormal behavior based on sampling, assumptions, and other heuristics about the activity in the system. One disadvantage of this approach is that samples, assumptions, and heuristics may not always be correct, which would lead to monitoring that is not reliable and robust in all cases. Another disadvantage of this approach is that it does not analyze the actual activity (e.g. processes or jobs executing in the system) but rather relies on analyzing statistics about the usage of resources (e.g. memory, CPU time, storage access and utilization) in order to determine whether the system is exhibiting an abnormal behavior.

Based on the foregoing, there is a clear need for an approach for efficient and deterministic monitoring of production systems in real-time that addresses the problems described above and overcomes the disadvantages of the described approaches.

### BRIEF DESCRIPTION OF THE DRAWINGS

In the figures of the accompanying drawings like reference numerals refer to similar elements.

FIG. 1 is a flow diagram that illustrates an overview of an example method for real-time monitoring of computer systems with repetitive production workloads according to one embodiment.

FIG. 2 is a block diagram that illustrates a technique for recording dispatches according to one embodiment.

FIG. 3 is a block diagram of an example computer system upon which embodiments may be implemented.

### DETAILED DESCRIPTION

In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention. Various aspects of the invention are described hereinafter in the following sections:
I. OVERVIEW
II. EXAMPLE EMBODIMENTS USING REDUCED PREEMPTION
III. RECORDING DISPATCHES AND GENERATING A BASELINE PROFILE
IV. MONITORING AND ANALYZING DISPATCHES TO DETECT ABNORMAL EXECUTION FLOWS
V. PERFORMING PREVENTIVE AND CORRECTIVE ACTIONS
VI. IMPLEMENTATION MECHANISMS

### I. OVERVIEW

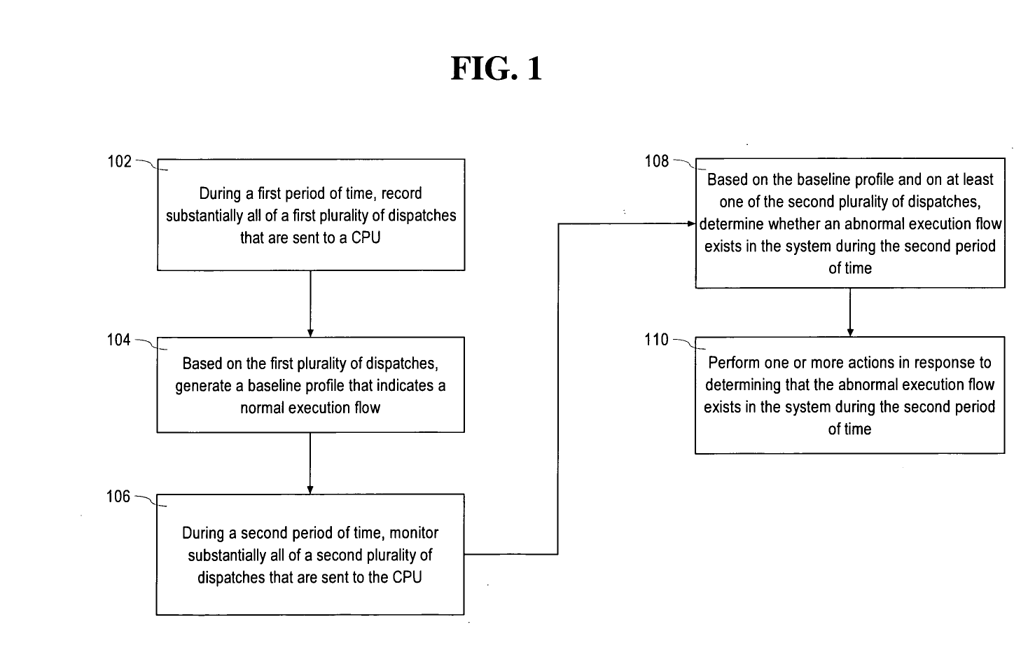

An approach is described herein for monitoring computer systems. FIG. 1 is a flow diagram that illustrates an overview of an example method for real-time, deterministic, and activity-based monitoring of computer systems with repetitive, consistent, and stable production workloads according to one embodiment.

In step 102, all or substantially all of a first plurality of dispatches, which are sent by a dispatcher to a Central Processing Unit (CPU) during a first period of time, are recorded. As used herein, a “dispatcher” refers to a process executing within an Operating System (OS) that is operable to schedule and send jobs (or units of work) to a CPU for execution. A “dispatch” refers to a set of information sent by a dispatcher to a CPU, where the set of information instructs the CPU which instruction to execute next. Each dispatch of the first plurality of dispatches indicates an initial instruction of a stream of instructions that is executed without interruption by the CPU. The first period of time during which the plurality of dispatches is recorded may depend on the nature of the repetitive production load in the computer system that is being monitored. For example, in different operational scenarios, the first period of time may be an interval of time during a particular day, a particular week, or a particular month during which a normal production load is executing in the production system.

Based on the first plurality of recorded dispatches, a baseline profile is generated in step 104. In some embodiments, the plurality of recorded dispatches may include dispatches that are monitored enough times to learn the ranges of normal variability between different executions. In this way, these embodiments provide for the generating a more reliable baseline profile over time. The baseline profile indicates a normal execution flow in the production system. As used herein, a “normal execution flow” refers to the execution, by a CPU, of a sequence of instruction streams, where the execution of the sequence of instruction streams is designated as the normal and expected workload in the system. A “baseline profile” refers to a set of information that characterizes the operation of the system under a normal execution flow. For example, in some operational scenarios an administrator or a power user may determine that during the first period of time the production system was executing a normal execution flow. In these operational scenarios, an input from the administrator or the power user may be received through a user interface, where the input designates the baseline profile as indicating the normal execution flow in the system that should be expected during corresponding later periods of time.

During a later, second period of time, all or substantially all of a second plurality of dispatches, which are sent by the dispatcher to the CPU, are monitored and traced in step 106. The second plurality of dispatches reflects the execution flow and the workload in the system during the second period of time. In some embodiments, the second plurality of dispatches may be recorded in a current workload profile, which may be later compared to the baseline profile. In other embodiments, each dispatch in the second plurality of dispatches may be compared to the dispatches recorded in the baseline profile in order to prevent or inspect abnormal execution before it occurs. If the changed execution flow is acceptable then the work associated with the dispatch being compared may be allowed to proceed and the dispatch may be added to the baseline profile.

In step 108, the second plurality of dispatches is analyzed. For example, based on the baseline profile and on a least one dispatch of the second plurality of dispatches, a determination may be made whether an abnormal execution flow exists in the system during the second period of time. As used herein, an “abnormal execution flow” refers to an execution flow that is different than a normal execution flow.

In response to determining that an abnormal execution flow exists in the system, in step 110 the abnormal execution may be analyzed and one or more corrective actions may be performed. For example, a notification may be sent to an administrator, where the notification indicates that the abnormal execution flow is detected in the system. In another example, a ticket may be automatically opened in a defect tracking system. In another example, the abnormal execution may be suspended pending an inspection if desired.

In other embodiments, the approach described herein may encompass a computer apparatus and a machine-readable medium configured and operable to carry out the steps of the example method illustrated in FIG. 1.

The approach described herein provides for the recording and monitoring of substantially all dispatches that are sent from an OS dispatcher to a CPU in a computer system. This allows for deterministic analysis and detection of abnormal behavior in real-time based on the actual instruction streams that are being executed in the computer system. In addition, since the number of dispatches sent by a dispatcher would be relatively small with respect to the number of all instructions that are executed by the CPU, the approach described herein does not result in any significant overhead while at the same time provides an accurate representation of substantially all jobs and processes that are executing in the system. Thus, the approach described herein provides numerous improvements over previous approaches that rely on sampling and/or heuristics to monitor production computer systems.

### II. EXAMPLE EMBODIMENTS USING REDUCED PREEMPTION

In some embodiments, the approach described herein may be implemented in computer systems that use reduced preemption to schedule jobs and processes for execution. “Reduced preemption” refers to a technique according to which a dispatcher would not normally preempt a currently executing process having a low priority in order to run a waiting process that has a higher priority. According to the reduced preemption technique, the dispatcher would normally let the lower priority process execute until the process voluntarily goes into a waiting state and releases the CPU; only in exceptional circumstances the dispatcher would preempt a currently running process. For example, the dispatcher may preempt a currently running process but only after this process has been running for an exceptionally long time (which effectively results in reduced preemption instead of no preemption at all).

The reduced preemption technique allows a process to run tens of thousands of instructions without the risk of being preempted regardless of the priority of the process. When eventually a process voluntarily releases the CPU (or is preempted in exceptional circumstances), the address of the current instruction of the process is stored and the context of the process is saved. Thereafter, when the dispatcher schedules the process to run again, the dispatcher retrieves the stored address, performs a context switch by loading the corresponding context, and sends a dispatch to the CPU identifying the next instruction that needs to be executed by the CPU. The CPU then continues to execute the process from the point in the instruction stream where it previously released the CPU (or was preempted in the exceptional circumstances).

In some embodiments, the approach described herein may be implemented in an OS executing on a mainframe computer system, where the OS dispatcher uses reduced preemption to schedule jobs for execution at the one or more CPUs of the system. In general, a mainframe computer system running a production workload executes programs and processes as batches or transactions in a time-shared fashion. Batch work and fast CPUs allow mainframe computer systems to be optimized for maximizing throughput and not user response times. Mainframe computer systems may execute hundreds or even thousands of processes and programs at the same time, and are thus suitable for bulk data processing.

For example, the approach described herein may be implemented in a z/OS operating system provided by IBM that may be executing on an IBM System z mainframe hardware platform. In this embodiment, the z/OS dispatcher uses reduced preemption algorithms to dispatch units of work to the mainframe CPUs, where the units of dispatchable work are processes that may be associated with particular Task Control Blocks (TCBs) or Service Request Blocks (SRBs). Instruction streams caused by CPU interrupts, such as I/O completions, can also be monitored if they are deemed significant. It is noted that the approach described herein is not limited to the z/OS operating system and the System z hardware platform. Rather, various embodiments of the approach may be implemented on any OS that is executing repetitive work on any hardware platform. For this reason, the described embodiments and the OS and hardware platforms thereof are to be regarded in an illustrative rather than a restrictive sense.

### III. RECORDING DISPATCHES AND GENERATING A BASELINE PROFILE

The approach for monitoring a computer system described herein provides for generating a baseline profile that characterizes the normal execution flow in the system. The baseline profile is generated based on all or substantially all dispatches, sent by a dispatcher to a CPU during a baseline period of time, that are traced and recorded for the purpose of identifying the jobs and processes that comprise the normal execution flow in the system. The baseline profile may include acceptable amounts of variability for the particular workload.

In one embodiment, an exit point may be registered with a dispatcher in order to capture, trace, and record substantially all dispatches that are sent by the dispatcher to a CPU. For example, the exit point may be a synchronous call that may be established in the dispatcher. After the exit point is activated, every time the dispatcher sends a dispatch to a CPU, the dispatcher transfers control to the exit point. Upon receiving control from the dispatcher, the exit point executes a monitor program that records information associated with the just-sent dispatch. After recording the information associated with the just-sent dispatch, the monitor program returns control to dispatcher and the dispatcher continues its execution. In this way, the dispatched initial instructions for all or substantially all instruction streams executing in the system during the baseline period of time are captured, and the information recorded thereof is used to generate a baseline profile indicating the normal execution flow in the system. Monitoring may be repeated as may times as necessary to learn normal variability.

The information associated with, and recorded for, each dispatch may include various data items in different operational scenarios. For example, in some embodiments the recorded dispatch information may include the address of the initial instruction of a particular instruction stream. (After receiving a dispatch identifying the initial instruction, the CPU proceeds to execute the particular instruction stream. The instruction stream ends when the stream releases the CPU or is preempted in exceptional circumstances.) Based on the address of the initial instruction, a hash table may be inspected and the dispatched initial instruction may be mapped to the particular program to which the dispatched instruction belongs. An identifier of the particular program and an offset in that program may then be recorded in the baseline profile in association with the dispatched instruction. In addition, the user that invoked the particular program may be identified in a similar manner, and the user ID thereof may also be recorded in the baseline profile in association with the dispatched initial instruction. Other contextual information, such as the transaction ID, may also be recorded in the baseline profile.

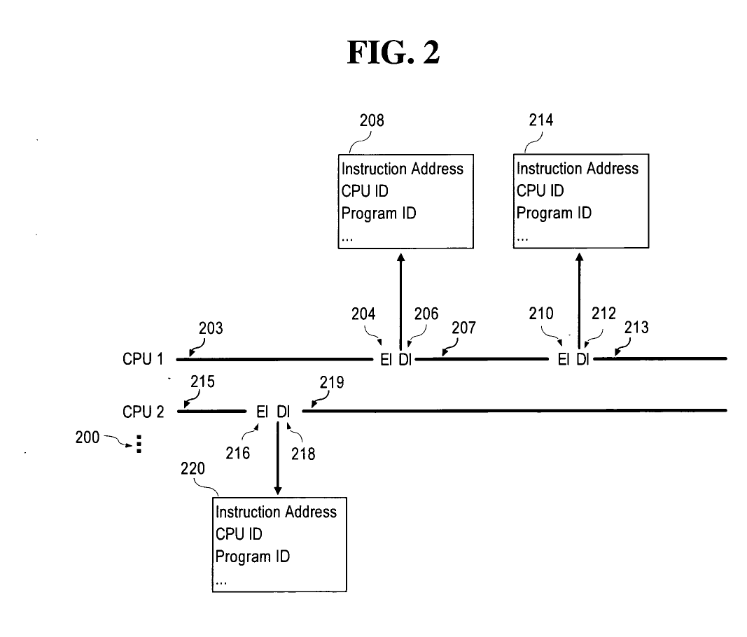

FIG. 2 is a block diagram that illustrates a technique for recording dispatches according to one embodiment. A computer system (not shown in FIG. 2) includes one or more CPUs 200, such as CPU 1 and CPU 2. At any particular point in time any CPU may be executing a stream of instructions, such as, for example, instruction streams 203, 207, and 213 executed by CPU 1, and instruction streams 215 and 219 executed by CPU 2.

After executing end instruction (El) 204 of instruction stream 203, CPU 1 ceases to execute instruction stream 203. (For example, instruction stream 203 may voluntarily release control of CPU 1 after instruction 204.) At this point, CPU 1's dispatcher sets up a dispatch that identifies dispatched instruction (D1) 206 as the next instruction that is to be executed by CPU 1. Dispatched instruction 206 identifies instruction stream 207 that is to be executed next by CPU 1. According to the approach described herein, the dispatch identifying dispatched instruction 206 is traced and recorded in record 208. For example, in one embodiment the dispatcher may transfer control to a pre-established exit point, and the exit point may invoke a monitor program to inspect the just-sent dispatch and to record the relevant dispatch information in record 208. Record 208 may include various data items associated with the just-sent dispatch including, but not limited to, the address of instruction 206, a timestamp indicating the time of the dispatch, and the CPU ID of CPU 1. Record 208 may also store additional information that may be determined based on the address of instruction 206, such as, for example, the program ID of the program to which instruction 206 belongs. In addition, record 208 may also store additional information that is not necessarily associated with, or determined based on, the just-sent dispatch.

After receiving the dispatch identifying instruction 206, CPU 1 proceeds to execute instruction stream 207. After executing end instruction 210, CPU 1 ceases to execute instruction stream 207. For example, instruction stream 207 may voluntarily release control of CPU 1 after instruction 210. At this point, the dispatcher sends to CPU 1, and CPU 1 receives, a dispatch that identifies dispatched instruction 212 as the next instruction that is to be executed by CPU 1. Dispatched instruction 212 identifies instruction stream 213 that is to be executed next by CPU 1. According to the approach described herein, the dispatch identifying dispatched instruction 212 is traced and recorded in record 214. Record 214 may include various data items associated with the just-sent dispatch including, but not limited to, the address of instruction 212, the CPU ID of CPU 1, and other information associated with instruction 212, for example the program ID of the program to which instruction 212 belongs.

Similarly to CPU 1, CPU 2 executes instruction stream 215 until it receives end instruction 216, after which instruction stream 215 releases control of CPU 2. At this point, the dispatcher sends to CPU 2, and CPU 2 receives, a dispatch that identifies dispatched instruction 218 as the next instruction that is to be executed by CPU 2. Dispatched instruction 218 identifies instruction stream 219 that is to be executed next by CPU 2. According to the approach described herein, the dispatch identifying dispatched instruction 218 is traced and recorded in record 220. Record 220 may include various data items associated with the just-sent dispatch including, but not limited to, the address of instruction 218, the CPU ID of CPU 2, and other information associated with instruction 218, for example the program ID of the program to which instruction 218 belongs.

In this manner, dispatch information associated with substantially all dispatches, sent by the dispatcher to CPU 1, CPU 2, and any other CPUs of the computer system during a baseline period of time, is traced and recorded in dispatch records, such as records 208, 214, and 220. (While in the example of FIG. 2 all depicted dispatches are traced and recorded, tracing and recording all dispatches is not necessarily required by the approach described herein.) After the baseline time period expires, a baseline profile is generated based on the dispatch records associated with substantially all dispatches that are sent by the dispatcher during the baseline period of time.

In some embodiments, in addition to the CPU ID of the CPU to which a dispatch is sent, the time at which the dispatch is sent to the CPU may also be recorded. The CPU ID and the time at which a dispatch is sent to the identified CPU may be recorded in the baseline profile, and may later be used to determine whether a corresponding, later-executed instruction stream identified by the same initial instruction is executing within the expected time limits and, if any CPUs are configured to run specific work, on the correct CPU. For example, in some embodiments implemented on the System z mainframe hardware platform, some CPUs called “specialty” processors may be configured to run particular types of workloads, instructions, applications, and/or operating systems, such as, for example, Java, DB2, or zLinux. The specialty processors are typically cheaper and may run faster than the normal CPUs, and thus it may be considered abnormal for certain types of instruction streams to run on normal CPUs.

In some embodiments, similar information may be recorded in the baseline profile for the end instruction in a stream of instructions that is executed by a CPU, where the end instruction is the instruction at which the stream of instruction voluntary releases the CPU (or is preempted in exceptional circumstances). In these embodiments, it may happen that the end instruction in the instruction stream belongs to a different program than the dispatched initial instruction of the same instruction stream because of runtime branching or function calls. For example, the dispatched initial instruction may be the entry point of a particular program, and the end instruction may be in the I/O subsystem of the OS, which has been called by the program to perform some I/O operation.

In some embodiments, the generated baseline profile may be organized as a hash table, in which the key would be information (e.g. address and type) identifying a dispatched instruction, the program to which the dispatched instruction belongs, and the transaction ID associated with the dispatched instruction. For example, in these embodiments the opcode of a dispatched instruction and the elapsed time between consecutive dispatches may be recorded in the baseline profile in addition to the address of the dispatched instruction. Based on the address of the dispatched instruction, a determination may be made of the program to which the instruction belongs. For example, a hash table may be maintained which indicates the starting and ending addresses of each program executing in the computer system, and this hash table may be used to identify the program to which a particular dispatched instruction belongs. The identity of the user executing the program may also be determined by inspecting associated control blocks.

In some embodiments, the baseline profile may be organized according to particular jobs and/or according to particular phases in each job. For example, a phase of a job may be the opening a file, and dispatches sent by a dispatcher may be monitored for instructions that open the file. The baseline profile may include the counts of the file-opening instructions, and a subsequent abnormal execution flow in the underlying computer system may be detected when subsequent dispatches for the file-opening instructions are performed more or less often than indicated in the baseline profile. In this embodiment, dispatch information (e.g. addresses of dispatched instructions) may be associated in the baseline profile with other information (e.g. specific types of instructions such as opening a file) in order to provide for more accurate detection of abnormal execution flows in the system.

In some embodiments, the baseline profile may be determined and generated based on the activity in the entire computer system where the entire activity is reflected by substantially all dispatches sent by the dispatcher in the system. In some embodiments, the baseline profile may be generated based on the activity (as reflected by a corresponding subset of all dispatches) that is associated with or generated by a certain program or a set of programs.

According to the approach for monitoring a computer system described herein, a baseline profile indicates a normal execution flow in the system. The baseline profile is generated based on information associated with dispatches that are sent from a dispatcher in the system. The generated baseline profile is used to determine whether any subsequent workload executed in the system results in an execution flow that is abnormal. In different operational contexts, what execution flow is designated is normal may change over time. For example, a new program may be introduced in the computer system to be run on a consistent basis. In this case, the approach described herein provides for amending the baseline profile to reflect a normal execution of the new program, and for thereafter using the new baseline profile to determine and detect abnormal execution flows in the system.

In some embodiments, separate baseline profiles may be created to reflect what is designated as normal execution flows during specified time periods, for example, for weekdays and for weekends.

In some embodiments, the approach for monitoring a computer system described herein may provide a user (e.g. an administrator) with an interface to periodically review the results of the detection of abnormal execution flows in the system. The interface may be operable to receive input from the user, where the input may modify a previously generated baseline profile to reclassify as normal some instruction streams and/or programs that were characterized based on the unmodified baseline profile as abnormal. Through the interface, the user may also provide input to delete execution flows that were previously characterized as normal or were changed to be abnormal. In this way, the approach described herein allows users to modify a baseline profile to specify which detected abnormal events would no longer be considered as abnormal with respect to this baseline profile.

### IV. MONITORING AND ANALYZING DISPATCHES TO DETECT ABNORMAL EXECUTION FLOWS

According to the approach for monitoring a computer system described herein, after a baseline profile indicating a normal execution flow in the system is generated, the dispatches sent to a CPU by a dispatcher during any subsequent time period are monitored, traced, and analyzed to determine whether an abnormal execution flow exists in the system.

In one embodiment, a plurality of dispatches sent from a dispatcher to a CPU is monitored and information associated therewith is recorded. The recorded dispatch information is then compared to the information stored in the baseline profile to detect whether any abnormal execution flow exists in the system. For example, if the comparison determines that a current dispatch includes the address of a dispatched instruction of a particular program that is not present in the baseline profile, then a conclusion may be made that the particular program is releasing the CPU at an unexpected point in its instruction stream. This may be considered as one indicator of abnormal behavior in the system, which abnormal behavior may be caused by an abnormal execution flow. In another example, the comparison of the current dispatches to the baseline profile may indicate that a particular instruction of a particular program is being dispatched by the dispatcher several times more than the baseline profile indicates. This may also be considered as an indicator of abnormal behavior in the system.

In general, various embodiments may use various criteria to determine whether inconsistencies between a baseline profile and currently monitored dispatches would constitute an abnormal behavior in the system. For example, any type of statistical computations may be performed on the data items collected from currently monitored dispatches that reflect currently executing instruction streams. In some embodiments, in order to minimize the overhead involved in the real-time analysis, simple approaches may be used for detecting abnormal behavior, for example, by comparing and matching to the baseline profile only on a few data items such as the type of a particular dispatched instruction. Thus, the examples of analyzing current dispatches based on a baseline profile described herein are to be regarded in an illustrative rather than a restrictive sense.

For example, in one embodiment the frequency distribution of the dispatched instructions may be determined across a specific time of the day and may be stored in the baseline profile. The hours of the day may be sliced into portions in which the workload is known to be or is designated as steady. In a particular portion of the day, the system may be considered as executing a normal execution flow when a first instruction is dispatched a first number of times, a second instruction is dispatched a second number of times, etc. This pattern of dispatching instructions may be recorded into the baseline profile; thereafter, the frequency distribution of the instructions dispatched during corresponding portions of subsequent days may be computed and compared to the frequency recorded in the baseline profile to detect abnormal behavior in the system.

In some embodiments, various metrics associated with monitored dispatches may be collected, computed, and included in the baseline profile. The metrics collected in association with subsequently monitored dispatches may then be compared to the metrics stored in the baseline profile to detect abnormal behavior in the system. In addition, in these embodiments the baseline profile may store pre-configured threshold values in association with some or all of the metrics. The threshold values may be used to make the baseline profile more or less sensitive to abnormal behavior in the system. For example, the baseline profile may include a threshold value which indicates that the detection of a certain dispatched instruction would be classified as abnormal behavior only if the number of subsequent dispatches that identify that instruction differs substantially from (e.g., exceeds or is substantially below) the threshold value.

In some embodiments, in order to provide for fast analysis, the baseline profile may include indicators in association with the recorded dispatched instructions, where the indicators may specify that certain dispatched instructions are more easily detectable than others. For example, in the baseline profile, dispatched instructions associated with the entry point of a program may be flagged in order to facilitate faster identification of the programs being executed.

In some embodiments, the generated baseline profile may include information that identifies the sequence in which a particular group of dispatches have been sent by the dispatcher. The sequence in which a particular group of dispatches have been sent may indicate a particular execution path involving one or more instruction streams. Thus, recording the sequence in which a particular group of dispatches have been sent allows the detection of subsequent dispatches that occur out of order, which would indicate that a different (possibly abnormal) execution path has been taken by the corresponding subsequent instruction streams in the system. It is noted that a baseline profile that reflects only counts of dispatched instructions may not be able to detect abnormal behavior that is characterized by a particular order in which instruction streams need to be executed in the system; however, a baseline profile based on sequences of dispatched instructions would catch such abnormal behavior. Thus, a baseline profile that records the sequences in which dispatched instructions have been sent may be used for a more complex and detailed analysis.

### V. PERFORMING PREVENTIVE AND CORRECTIVE ACTIONS

According to the approach for monitoring a computer system described herein, one or more preventive and/or corrective actions may be performed in response to detecting an abnormal execution flow in the system.

One example corrective action may include sending an e-mail or other notification to a user such as an administrator, where the e-mail or other notification indicates that the abnormal execution flow has been detected in the system.

Another example of a corrective action may include automatically opening a ticket in a defect tracking system, where the ticket indicates that the abnormal execution flow has been detected.

Another example of a corrective action may involve running a particular program that may correct, analyze, or otherwise affect the detected abnormal execution flow. In some embodiments, a baseline profile may specify different programs that are to be run when different abnormal execution flows are detected.

One example of a preventive action may be to suspend one or more units of work when a dispatch indicating an abnormal execution flow is first detected. A user or a policy can then determine whether to cancel the one or more units of work involved or to allow them to continue. In some embodiments, the approach described herein may be used to detect and prevent the execution of instruction streams that execute viruses or other functions that are determined to be potentially detrimental and therefore not to be allowed. In these embodiments, when a dispatch indicating the execution of a virus or other type of function is detected, the preventive action may include canceling the unit of work for which the dispatch was generated.

In some embodiments, one or more policies may be stored in the computer system that is being monitored, where the one or more policies may indicate the preventive and corrective actions that may be performed when various abnormal execution flows are detected. In these embodiments, the one or more policies may be stored in the baseline profile or in other storage structures supported and maintained by the computer system being monitored.

The approach for monitoring a computer system described herein is not limited to any particular type of preventive or corrective actions that may be performed in response to detecting an abnormal execution flow in the system. For this reason, the examples of preventive and corrective actions described herein are to be regarded in an illustrative rather than a restrictive sense.

### VI. IMPLEMENTATION MECHANISMS

The approach described herein for monitoring of computer systems with repetitive workloads may be implemented in any context and on any kind of computing platform or architecture and is not otherwise limited to any particular context, computing platform, or architecture.

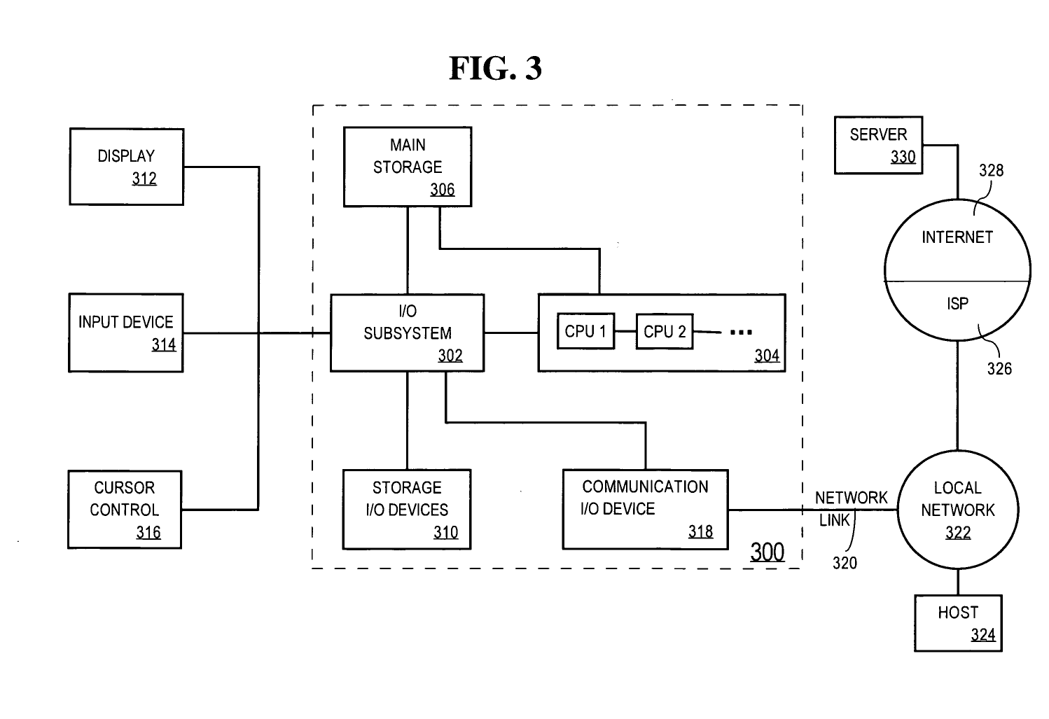

For purposes of explanation, FIG. 3 is a block diagram that illustrates an example computer system 300 upon which an embodiment may be implemented. In some embodiments, computer system 300 may be a mainframe computer system including virtualized components, where each logical partition in which an operating system executes uses parts of the underlying physical hardware. In these embodiments, some system resources may be dedicated and other system resources, such as CPUs, may be time-sliced or assigned dynamically in response to system load.

Computer system 300 includes Input/Output (I/O) subsystem 302 or other mechanism for supporting I/O operations, and one or more processors 304 coupled with I/O subsystem 302 for processing information. Computer system 300 also includes a main storage 306, such as a random access memory (RAM) or other dynamic storage device, coupled to I/O subsystem 302 and processors 304 for storing information and instructions to be executed by processors 304. Main storage 306 also may be used for storing temporary variables or other intermediate information during execution of instructions to be executed by processors 304. One or more storage I/O devices 310, such as magnetic disks or optical disks, are provided and coupled to I/O subsystem 302 for storing information and instructions. I/O subsystem 302 controls the transfer of data, information, and instructions between main storage 306 and the storage I/O devices 310. I/O subsystem 302 communicates with the I/O devices provided in computer system 300 and permits data processing at processors 304 to proceed concurrently with I/O processing.

Computer system 300 may be coupled via I/O subsystem 302 to a display 312 for displaying information to a computer user. An input device 314, including alphanumeric and other keys, is coupled to I/O subsystem 302 for communicating information and command selections to processors 304. Another type of user input device is cursor control 316, such as a mouse, a trackball, or cursor direction keys for communicating direction information and command selections to processors 304 and for controlling cursor movement on display 312. This input device typically has two degrees of freedom in two axes, a first axis (e.g., x) and a second axis (e.g., y), that allows the device to specify positions in a plane. In some embodiments, display 312, input device 314, and cursor control 316 may be implemented as an emulator that is coupled to I/O subsystem 312 through a communication device over a network protocol, such as TCP/IP.

The invention is related to the use of computer system 300 for implementing the approach described herein. According to one embodiment, this approach is performed by computer system 300 in response to processors 304 executing one or more sequences of one or more instructions contained in main storage 306. Such instructions may be read into main storage 306 from another machine-readable medium, such as storage I/O devices 310. Execution of the sequences of instructions contained in main storage 306 causes processors 304 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operate in a specific fashion. In an embodiment implemented using computer system 300, various machine-readable media are involved, for example, in providing instructions to processors 304 for execution. Such a medium may take many forms, including but not limited to, non-volatile media, volatile media, and transmission media. Non-volatile media includes, for example, optical or magnetic disks, such as storage I/O devices 310. Volatile media includes dynamic memory, such as, for example, main storage 306. Transmission media includes coaxial cables, copper wire and fiber optics, including the wires that comprise I/O subsystem 302. Transmission media can also take the form of electromagnetic or light waves, such as those generated during radio-wave and infra-red data communications.

Common forms of machine-readable media include, for example, a floppy disk, a flexible disk, hard disk, magnetic tape, or any other magnetic medium, a CD-ROM, any other optical medium, a RAM, a PROM, an EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processors 304 for execution. For example, the instructions may initially be carried on a magnetic disk of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data in a channel supported by I/O subsystem 302. I/O subsystem 302 carries the data to main storage 306, from which processors 304 retrieve and execute the instructions. The instructions received by main storage 306 may optionally be stored on one of storage I/O devices 310 either before or after execution by processors 304.

Computer system 300 also includes a communication I/O device 318 coupled to I/O subsystem 302. Communication I/O device 318 provides a two-way data communication coupling to a network link 320 that is connected to a local network 322. For example, communication I/O device 318 may be a Digital Subscriber Line (DSL) card, a cable modem, or a modem to provide a data communication connection to a corresponding type of telephone line. As another example, communication I/O device 318 may be a local area network (LAN) card to provide a data communication connection to a compatible LAN. Wireless links may also be implemented. In any such implementation, communication I/O device 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the worldwide packet data communication network now commonly referred to as the Internet 328. Local network 322 and Internet 328 both use electrical, electromagnetic or optical signals that carry digital data streams. The signals through the various networks and the signals on network link 320 and through communication I/O device 318, which carry the digital data to and from computer system 300, are exemplary forms of carrier waves transporting the information.

Computer system 300 can send messages and receive data, including program code, through the network(s), network link 320 and communication I/O device 318. In the Internet example, a server 330 might transmit a requested code for an application program through Internet 328, ISP 326, local network 322 and communication I/O device 318. The received code may be executed by processors 304 as it is received, and/or stored in storage I/O devices 310, or other non-volatile storage for later execution. In this manner, computer system 300 may obtain application code in the form of a carrier wave.

In the foregoing specification, embodiments of the invention have been described with reference to numerous specific details that may vary from implementation to implementation. Thus, the sole and exclusive indicator of what is, and is intended by the applicants to be, the invention is the set of claims that issue from this application, in the specific form in which such claims issue, including any subsequent correction. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer-implemented method for real-time monitoring of a system with repetitive production workloads, the computer-implemented method comprising:
during a first period of time, recording substantially all of a first plurality of dispatches that are sent by a dispatcher to a Central Processing Unit (CPU), wherein each dispatch of the first plurality of dispatches indicates at least an initial instruction of a stream of instructions that is executed by the CPU until the stream of instructions voluntarily returns to the dispatcher;
based on the first plurality of dispatches, generating a baseline profile that indicates a normal execution flow in the system;
during a second period of time, monitoring substantially all of a second plurality of dispatches that are sent to the CPU;
based on the baseline profile and on at least one of the second plurality of dispatches, determining whether an abnormal execution flow exists in the system during the second period of time; and
performing one or more actions in response to determining that the abnormal execution flow exists in the system during the second period of time.

2. The computer-implemented method as recited in claim 1, wherein:
the system is a mainframe computer system comprising the CPU, wherein the CPU is a specialty processor configured to execute a particular type of workload; and
the first plurality of dispatches and the second plurality of dispatches are sent to the CPU by the dispatcher that schedules jobs for execution by the CPU.

3. The computer-implemented method as recited in claim 1, wherein each particular dispatch of the first plurality of dispatches includes a particular address of the initial instruction indicated by that particular dispatch.

4. The computer-implemented method as recited in claim 3, wherein:
each particular dispatch of the first plurality of dispatches further includes first data identifying the CPU to which the dispatch is sent; and
generating the baseline profile comprises recording, for each particular dispatch of the first plurality of dispatches, a particular time at which that particular dispatch is sent to the CPU.

5. The computer-implemented method as recited in claim 3, wherein generating the baseline profile comprises:
based on the particular address included in each particular dispatch, determining a particular program and an offset that are associated with that particular dispatch; and
for each particular dispatch, recording in the baseline profile first data that identifies the particular program and the offset that are associated with that particular dispatch.

6. The computer-implemented method as recited in claim 1, wherein generating the baseline profile comprises:
identifying, in the first plurality of dispatches, a set of dispatches that are associated with a particular job that is part of the normal execution flow in the system; and
recording, in the baseline profile, first data that associates the set of dispatches with the particular job.

7. The computer-implemented method as recited in claim 1, wherein generating the baseline profile comprises:
identifying, in the first plurality of dispatches, a set of dispatches that are associated with a particular phase of a particular job that is part of the normal execution flow in the system; and
recording, in the baseline profile, first data that associates the set of dispatches with the particular phase of the particular job.

8. The computer-implemented method as recited in claim 1, wherein the first period of time represents an interval of time during a particular day of the week, and the second period of time represents a corresponding interval during the same particular day of any subsequent week.

9. The computer-implemented method as recited in claim 1, further comprising:
receiving input from a user, wherein the input designates the normal execution flow in the system; and
modifying the baseline profile based on the input.

10. The computer-implemented method as recited in claim 1, wherein:
generating the baseline profile comprises storing the first plurality of dispatches in the baseline profile; and
determining whether the abnormal execution flow exists in the system comprises determining whether one or more dispatches of the second plurality of dispatches are not present in the baseline profile.

11. The computer-implemented method as recited in claim 1, wherein:
generating the baseline profile comprises determining a first frequency with which a first dispatch of the first plurality of dispatches occurred during the first period of time;
monitoring the second plurality of dispatches comprises determining a second frequency with which a second dispatch of the second plurality of dispatches occurred during the second period of time, wherein the second dispatch corresponds to the first dispatch; and
determining whether the abnormal execution flow exists in the system comprises determining whether the second frequency matches the first frequency.

12. The computer-implemented method as recited in claim 1, wherein:
generating the baseline profile comprises storing a first threshold metric that is associated with a first dispatch of the first plurality of dispatches;
monitoring the second plurality of dispatches comprises determining a second metric that is associated with a second dispatch of the second plurality of dispatches, wherein the second dispatch corresponds to the first dispatch; and
determining whether the abnormal execution flow exists in the system comprises determining whether the second metric differs substantially from the first threshold metric.

13. The computer-implemented method as recited in claim 1, wherein performing the one or more actions comprises suspending a unit of work that is associated with the at least one dispatch of the second plurality of dispatches, wherein the unit of work is about to execute a virus or a function that is not to be allowed.

14. The computer-implemented method as recited in claim 1, wherein performing the one or more actions comprises at least one of:
sending a notification to a user, wherein the notification indicates that the abnormal execution flow exists in the system during the second period of time;
automatically opening a ticket in a defect tracking system, wherein the ticket indicates that the abnormal execution flow exists in the system during the second period of time;
executing a particular program that is associated with the abnormal execution flow;
accessing a particular policy that is associated with the abnormal execution flow, wherein the particular policy specifies the one or more actions; and
suspending a unit of work that is determined in the abnormal execution flow, wherein suspending the unit of work further comprises receiving input which indicates whether execution of the unit of work is to be canceled.

15. A machine-readable medium for real-time monitoring of a system with repetitive production workloads, the machine-readable medium carrying one or more sequences of instructions which, when processed by one or more Central Processing Units (CPUs), cause:
during a first period of time, recording substantially all of a first plurality of dispatches that are sent by a dispatcher to a CPU, wherein each dispatch of the first plurality of dispatches indicates at least an initial instruction of a stream of instructions that is executed by the CPU until the stream of instructions voluntarily returns to the dispatcher;
based on the first plurality of dispatches, generating a baseline profile that indicates a normal execution flow in the system;
during a second period of time, monitoring substantially all of a second plurality of dispatches that are sent to the CPU;
based on the baseline profile and on at least one of the second plurality of dispatches, determining whether an abnormal execution flow exists in the system during the second period of time; and
performing one or more actions in response to determining that the abnormal execution flow exists in the system during the second period of time.

16. The machine-readable medium as recited in claim 15, wherein:
the system is a mainframe computer system comprising the CPU, wherein the CPU is a specialty processor configured to execute a particular type of workload; and
the first plurality of dispatches and the second plurality of dispatches are sent to the CPU by the dispatcher that schedules jobs for execution by the CPU.

17. The machine-readable medium as recited in claim 15, wherein each particular dispatch of the first plurality of dispatches includes a particular address of the initial instruction indicated by that particular dispatch.

18. The machine-readable medium as recited in claim 17, wherein:
each particular dispatch of the first plurality of dispatches further includes first data identifying the CPU to which the dispatch is sent; and
the instructions that cause generating the baseline profile comprise instructions which, when processed by the one or more CPUs, cause recording, for each particular dispatch of the first plurality of dispatches, a particular time at which that particular dispatch is sent to the CPU.

19. The machine-readable medium as recited in claim 17, wherein the instructions that cause generating the baseline profile comprise instructions which, when processed by the one or more CPUs, cause:
based on the particular address included in each particular dispatch, determining a particular program and an offset that are associated with that particular dispatch; and
for each particular dispatch, recording in the baseline profile first data that identifies the particular program and the offset that are associated with that particular dispatch.

20. The machine-readable medium as recited in claim 15, wherein the instructions that cause generating the baseline profile comprise instructions which, when processed by the one or more CPUs, cause:
identifying, in the first plurality of dispatches, a set of dispatches that are associated with a particular job that is part of the normal execution flow in the system; and
recording, in the baseline profile, first data that associates the set of dispatches with the particular job.

21. The machine-readable medium as recited in claim 15, wherein the instructions that cause generating the baseline profile comprise instructions which, when processed by the one or more CPUs, cause:
identifying, in the first plurality of dispatches, a set of dispatches that are associated with a particular phase of a particular job that is part of the normal execution flow in the system; and
recording, in the baseline profile, first data that associates the set of dispatches with the particular phase of the particular job.

22. The machine-readable medium as recited in claim 15, wherein the first period of time represents an interval of time during a particular day of the week, and the second period of time represents a corresponding interval during the same particular day of any subsequent week.

23. The machine-readable medium as recited in claim 15, wherein the one or more sequences of instructions further comprise instructions which, when processed by the one or more CPUs, cause:
receiving input from a user, wherein the input designates the normal execution flow in the system; and
modifying the baseline profile based on the input.

24. The machine-readable medium as recited in claim 15, wherein:
the instructions that cause generating the baseline profile comprise instructions which, when processed by the one or more CPUs, cause storing the first plurality of dispatches in the baseline profile; and
the instructions that cause determining whether the abnormal execution flow exists in the system comprise instructions which, when processed by the one or more CPUs, cause determining whether one or more dispatches of the second plurality of dispatches are not present in the baseline profile.

25. The machine-readable medium as recited in claim 15, wherein:
the instructions that cause generating the baseline profile comprise instructions which, when processed by the one or more CPUs, cause determining a first frequency with which a first dispatch of the first plurality of dispatches occurred during the first period of time;
the instructions that cause monitoring the second plurality of dispatches comprise instructions which, when processed by the one or more CPUs, cause determining a second frequency with which a second dispatch of the second plurality of dispatches occurred during the second period of time, wherein the second dispatch corresponds to the first dispatch; and
the instructions that cause determining whether the abnormal execution flow exists in the system comprise instructions which, when processed by the one or more CPUs, cause determining whether the second frequency matches the first frequency.

26. The machine-readable medium as recited in claim 15, wherein:
the instructions that cause generating the baseline profile comprise instructions which, when processed by the one or more CPUs, cause storing a first threshold metric that is associated with a first dispatch of the first plurality of dispatches;
the instructions that cause monitoring the second plurality of dispatches comprise instructions which, when processed by the one or more CPUs, cause determining a second metric that is associated with a second dispatch of the second plurality of dispatches, wherein the second dispatch corresponds to the first dispatch; and
the instructions that cause determining whether the abnormal execution flow exists in the system comprise instructions which, when processed by the one or more CPUs, cause determining whether the second metric differs substantially from the first threshold metric.

27. The machine-readable medium as recited in claim 15, wherein the instructions that cause performing the one or more actions comprise instructions which, when processed by the one or more CPUs, cause suspending a unit of work that is associated with the at least one dispatch of the second plurality of dispatches, wherein the unit of work is about to execute a virus or function that is not to be allowed.

28. The machine-readable medium as recited in claim 15, wherein the instructions that cause performing the one or more actions comprise instructions which, when processed by the one or more CPUs, cause at least one of:
sending a notification to a user, wherein the notification indicates that the abnormal execution flow exists in the system during the second period of time;
automatically opening a ticket in a defect tracking system, wherein the ticket indicates that the abnormal execution flow exists in the system during the second period of time;
executing a particular program that is associated with the abnormal execution flow;
accessing a particular policy that is associated with the abnormal execution flow, wherein the particular policy specifies the one or more actions; and
suspending a unit of work that is determined in the abnormal execution flow, wherein suspending the unit of work further comprises receiving input which indicates whether execution of the unit of work is to be canceled.

29. A system operable to process repetitive production workloads, the system comprising:
one or more Central Processing Units (CPUs); and
a machine-readable medium carrying one or more sequences of instructions which, when processed by the one or more CPUs, cause:
during a first period of time, recording substantially all of a first plurality of dispatches that are sent by a dispatcher to a CPU, wherein each dispatch of the first plurality of dispatches indicates at least an initial instruction of a stream of instructions that is executed by the CPU until the stream of instructions voluntarily returns to the dispatcher;
based on the first plurality of dispatches, generating a baseline profile that indicates a normal execution flow in the system;
during a second period of time, monitoring substantially all of a second plurality of dispatches that are sent to the CPU;
based on the baseline profile and on at least one of the second plurality of dispatches, determining whether an abnormal execution flow exists in the system during the second period of time; and
performing one or more actions in response to determining that the abnormal execution flow exists in the system during the second period of time.

30. The system as recited in claim 29, wherein:
the system is a mainframe computer system comprising the CPU, wherein the CPU is a specialty processor configured to execute a particular type of workload; and
the machine-readable medium comprises an Operating System (OS) which, when processed by the plurality of CPUs, is operable to execute the dispatcher to schedule jobs for execution by the CPU, wherein the dispatcher is operable to send the first plurality of dispatches and the second plurality of dispatches to the CPU.

31. The system as recited in claim 29, wherein each particular dispatch of the first plurality of dispatches includes a particular address of the initial instruction indicated by that particular dispatch.

32. The system as recited in claim 31, wherein:
each particular dispatch of the first plurality of dispatches further includes first data identifying the CPU to which the dispatch is sent; and
the instructions that cause generating the baseline profile comprise instructions which, when processed by the one or more CPUs, cause recording, for each particular dispatch of the first plurality of dispatches, a particular time at which that particular dispatch is sent to the CPU.

33. The system as recited in claim 31, wherein the instructions that cause generating the baseline profile comprise instructions which, when processed by the one or more CPUs, cause:
based on the particular address included in each particular dispatch, determining a particular program and an offset that are associated with that particular dispatch; and
for each particular dispatch, recording in the baseline profile first data that identifies the particular program and the offset that are associated with that particular dispatch.

34. The system as recited in claim 29, wherein the instructions that cause generating the baseline profile comprise instructions which, when processed by the one or more CPUs, cause:
identifying, in the first plurality of dispatches, a set of dispatches that are associated with a particular job that is part of the normal execution flow in the system; and
recording, in the baseline profile, first data that associates the set of dispatches with the particular job.

35. The system as recited in claim 29, wherein the instructions that cause generating the baseline profile comprise instructions which, when processed by the one or more CPUs, cause:
identifying, in the first plurality of dispatches, a set of dispatches that are associated with a particular phase of a particular job that is part of the normal execution flow in the system; and
recording, in the baseline profile, first data that associates the set of dispatches with the particular phase of the particular job.

36. The system as recited in claim 29, wherein the first period of time represents an interval of time during a particular day of the week, and the second period of time represents a corresponding interval during the same particular day of any subsequent week.

37. The system as recited in claim 29, wherein the one or more sequences of instructions further comprise instructions which, when processed by the one or more CPUs, cause:
receiving input from a user, wherein the input designates the normal execution flow in the system; and
modifying the baseline profile based on the input.

38. The system as recited in claim 29, wherein:
the instructions that cause generating the baseline profile comprise instructions which, when processed by the one or more CPUs, cause storing the first plurality of dispatches in the baseline profile; and
the instructions that cause determining whether the abnormal execution flow exists in the system comprise instructions which, when processed by the one or more CPUs, cause determining whether one or more dispatches of the second plurality of dispatches are not present in the baseline profile.

39. The system as recited in claim 29, wherein:
the instructions that cause generating the baseline profile comprise instructions which, when processed by the one or more CPUs, cause determining a first frequency with which a first dispatch of the first plurality of dispatches occurred during the first period of time;
the instructions that cause monitoring the second plurality of dispatches comprise instructions which, when processed by the one or more CPUs, cause determining a second frequency with which a second dispatch of the second plurality of dispatches occurred during the second period of time, wherein the second dispatch corresponds to the first dispatch; and
the instructions that cause determining whether the abnormal execution flow exists in the system comprise instructions which, when processed by the one or more CPUs, cause determining whether the second frequency matches the first frequency.

40. The system as recited in claim 29, wherein:
the instructions that cause generating the baseline profile comprise instructions which, when processed by the one or more CPUs, cause storing a first threshold metric that is associated with a first dispatch of the first plurality of dispatches;
the instructions that cause monitoring the second plurality of dispatches comprise instructions which, when processed by the one or more CPUs, cause determining a second metric that is associated with a second dispatch of the second plurality of dispatches, wherein the second dispatch corresponds to the first dispatch; and
the instructions that cause determining whether the abnormal execution flow exists in the system comprise instructions which, when processed by the one or more CPUs, cause determining whether the second metric differs substantially from the first threshold metric.

41. The system as recited in recited in claim 29, wherein the instructions that cause performing the one or more actions comprise instructions which, when processed by the one or more CPUs, cause suspending a unit of work that is associated with the at least one dispatch of the second plurality of dispatches, wherein the unit of work is about to execute a virus or a function that is not to be allowed.

42. The system as recited in claim 29, wherein the instructions that cause performing the one or more actions comprise instructions which, when processed by the one or more CPUs, cause at least one of:
sending a notification to a user, wherein the notification indicates that the abnormal execution flow exists in the system during the second period of time;
automatically opening a ticket in a defect tracking system, wherein the ticket indicates that the abnormal execution flow exists in the system during the second period of time;
executing a particular program that is associated with the abnormal execution flow;
accessing a particular policy that is associated with the abnormal execution flow, wherein the particular policy specifies the one or more actions; and
suspending a unit of work that is determined in the abnormal execution flow, wherein suspending the unit of work further comprises receiving input which indicates whether execution of the unit of work is to be canceled.
